(19) United States
(12) Patent Application Publication
(10) Pub. No.: US 2014/0222585 A1
(43) Pub. Date: Aug. 7, 2014

(54) NETWORK DEVICE AND NETWORK CONTROL DEVICE

(71) Applicant: Electronics and Telecommunications Research Institute, Daejeon (KR)

(72) Inventors: Jeu Young KIM, Seoul (KR); Ji Hyun LEE, Daejeon (KR); Kwang Il LEE, Daejeon (KR); Jun Hee PARK, Daejeon (KR)

(73) Assignee: Electronics and Telecommunications Research Institute, Daejeon (KR)

(21) Appl. No.: 14/172,433

(22) Filed: Feb. 4, 2014

(30) Foreign Application Priority Data
Feb. 6, 2013 (KR) 10-2013-0013535

(51) Int. Cl. G06Q 30/02

(52) U.S. Cl. CPC G06Q 30/0273; G06Q 30/0277
USPC 705/14.69; 705/14.73

(57) ABSTRACT

An advertisement content posting system and method are disclosed. The advertisement content posting system may include a resource collecting unit to collect resources included in a particular domain and configured to post an advertisement content, a service providing unit to provide an advertiser with resource object information of the collected resources and resource relationship information between resources in a web service form, and a post unit to post the advertisement content through resources selected by the advertiser when a post request with respect to the advertisement content is received from the advertiser.

### CROSS-REFERENCE TO RELATED APPLICATION

This application claims the benefit of Korean Patent Application No. 10-2013-0013535, filed on Feb. 6, 2013, in the Korean Intellectual Property Office, the disclosure of which is incorporated herein by reference.

### BACKGROUND

1. Field of the Invention

The present invention relates to an advertisement content posting system and method based on a resource management web service, and more particularly, to an advertisement content posting system that collectively manages resources for posting the advertisement content, positions, and network information through resource recycling, and posts the advertisement content on resources selected by an advertiser.

2. Description of the Related Art

In a conventional advertisement service that posts advertisements, the advertisement service posts contents in a limited space through a predetermined device. Since the advertisement service posts the contents using the predetermined device, advertisement cost increases corresponding to a post duration. In addition, since the posting space of the advertisement service is limited, not all users who want advertisement posting are allowed to post advertisements.

With recent development in the network environment, a technology of utilizing not only the predetermined device but also information, such as a network, a service, a content, and user information, is developed and therefore various advertisement posting devices are introduced. The advertisement service may post contents using an application development environment based on an open platform. In addition, as small-scale internet malls are spreading and a convenient content production environment is developed, roles between a consumer and a seller are not separated in the advertisement service and the space is not limited.

However, since the advertisements are posted without a space limit and distinguishment between consumers and sellers, the advertisement service may not provide collective management with respect to a posting device and the contents.

### SUMMARY

An aspect of the present invention provides an advertisement content posting system capable of conveniently posting advertisements as desired by an advertiser, by collecting resources capable of posting an advertisement content and providing the advertiser with resource object information and resource relationship information of the resources in the form of a web service.

Another aspect of the present invention provides an advertisement content posting system enabling a small-scale seller demanding advertising to more conveniently post an offline advertisement, by providing resources capable of posting an advertisement content remotely through a web service.

Still another aspect of the present invention provides an advertisement content posting system capable of establishing an advertisement plan with an increased advertisement posting efficiency, by not only providing resources capable of posting an advertisement content but also collecting information resources such as mobile customer information, network information, and position information related to the resources and providing the information resources to an advertiser.

According to an aspect of the present invention, there is provided an advertisement content posting system including a resource collecting unit to collect resources included in a particular domain and configured to post an advertisement content; a service providing unit to provide an advertiser with resource object information of the collected resources and resource relationship information between resources in a web service form; and a post unit to post the advertisement content through resources selected by the advertiser when a post request with respect to the advertisement content is received from the advertiser.

The post unit may include a schedule management unit to manage a post schedule related to the advertisement content corresponding to the post request; and a charge unit to calculate a charge for use of the resources posting the advertisement content, in consideration of at least one of the resources, the post schedule, and a post time according to the post schedule.

The schedule management unit may manage a redundant schedule by checking the post schedule of the resources corresponding to the post request, and manage a new schedule related to new registration of a post schedule of the resources or cancellation of the new registration

The charge unit may calculate the charge corresponding to at least one of an installation position of the resources, a size of the resources, the post schedule of the resources, floating population information at the installation position, an intensive post time, and an advertisement post plan.

The resources may include advertisement medium resources that post the advertisement content or operate according to the advertisement post plan, and advertisement medium information resources that include attribute information related to the advertisement medium resources.

The service providing unit may objectize the resources into the resource object information corresponding to a type of the resources posting the advertisement content.

The resource object information may include at least one piece of attribute information among a resource name, a resource type, an identifier (ID), state information, and a provided function related to the objectized resources.

The service providing unit may generate resource relationship information according to relationship with the resource object information, in consideration of the particular domain including the resources.

The resource relationship information may include at least one of a relationship name, a relationship type, and ID and source resource object or ID and target resource objet, according to relationship with the resource object information.

The post unit may post the advertisement content through the resources selected by the advertiser according to the post request when the charge according to the post schedule of the advertiser is paid.

According to another aspect of the present invention, there is provided an advertisement content posting method including collecting resources included in a particular domain and configured to post an advertisement content; providing an advertiser with resource object information of the collected resources and resource relationship information between resources in a web service form; and posting the advertisement content through resources selected by the advertiser when a post request with respect to the advertisement content is received from the advertiser.

The posting of the advertisement content may include managing a post schedule related to the advertisement content corresponding to the post request; and calculating a charge for use of the resources posting the advertisement content, in consideration of at least one of the resources, the post schedule, and a post time according to the post schedule.

The managing may include managing a redundant schedule by checking the post schedule of the resources corresponding to the post request, and manage a new schedule related to new registration of a post schedule of the resources or cancellation of the new registration.

The calculating may include calculating the charge corresponding to at least one of an installation position of the resources, a size of the resources, the post schedule of the resources, floating population information at the installation position, an intensive post time, and an advertisement post plan.

The resources may include advertisement medium resources that post the advertisement content or operate according to the advertisement post plan, and advertisement medium information resources that include attribute information related to the advertisement medium resources.

The providing may include objectizing the resources into the resource object information corresponding to a type of the resources posting the advertisement content.

The resource object information may include at least one piece of attribute information among a resource name, a resource type, an identifier (ID), state information, and a provided function related to the objectized resources.

The providing may include generating resource relationship information according to relationship with the resource object information, in consideration of the particular domain including the resources.

The resource relationship information may include at least one of a relationship name, a relationship type, and ID and source resource object or ID and target resource objet, according to relationship with the resource object information.

The posting of the advertisement content may include posting the advertisement content through the resources selected by the advertiser according to the post request when the charge according to the post schedule of the advertiser is paid.

### EFFECT

According to embodiments of the present invention, an advertisement content posting system may conveniently post advertisements as desired by an advertiser, by collecting resources capable of posting an advertisement content and providing the advertiser with resource object information and resource relationship information of the resources in the form of a web service.

Additionally, according to embodiments of the present invention, an advertisement content posting system may enable a small-scale seller demanding advertising to more conveniently post an offline advertisement, by providing resources capable of posting an advertisement content remotely through a web service.

Additionally, according to embodiments of the present invention, an advertisement content posting system may establish an advertisement plan with an increased advertisement posting efficiency, by not only providing resources capable of posting an advertisement content but also collecting information resources such as mobile customer information, network information, and position information related to the resources and providing the information resources to an advertiser.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an advertisement content posting system according to an embodiment of the present invention;

FIG. 2 is a diagram illustrating a detailed configuration of an advertisement content posting system according to an embodiment of the present invention;

FIG. 3 is a diagram illustrating a detailed configuration of resources capable of posting an advertisement content according to an embodiment of the present invention;

FIG. 4 is a diagram illustrating resource object information according to an embodiment of the present invention;

FIG. 5 is a diagram illustrating resource relationship information according to an embodiment of the present invention;

FIG. 6 is a diagram illustrating advertisement schedule information according to an embodiment of the present invention; and

FIG. 7 is a diagram illustrating an advertisement content posting method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout.

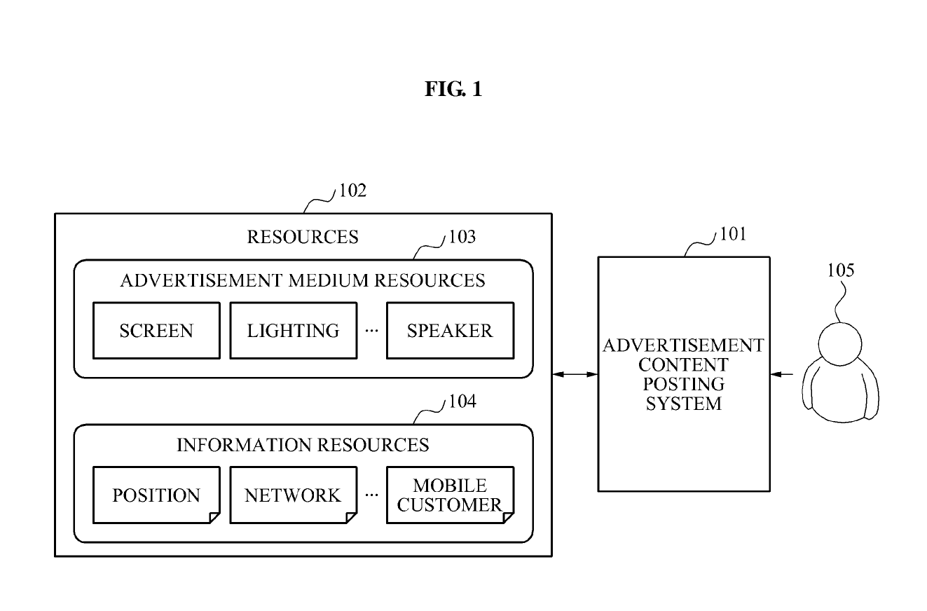

FIG. 1 is a diagram illustrating an advertisement content posting system 101 according to an embodiment of the present invention.

Referring to FIG. 1, the advertisement content posting system 101 may be a system that posts an advertisement content based on a web service. The advertisement content posting system 101 may post an advertisement content of an advertiser 105 more efficiently, by allowing the advertiser 105 who wants advertisement posting to freely access resources 102 capable of posting the advertisement content.

The advertisement content posting system 101 may collect the resources 102 which are included in a particular domain and capable of posting the advertisement content. The particular domain may refer to a building or structure for dwelling or industrial use. For example, the particular domain may include a lobby, male and female restrooms, an emergency exit, a roof, a parking lot entrance and exit, and the like of an apartment, a building, a shopping mall, or other particular spaces,

The resources 102 may refer to a device or a network device included and installed in the particular domain. For example, the resources 102 may include a device such as a screen, a speaker, and a television (TV), or the network device connected to the device, such as a local area network (LAN). The resources 102 may include advertisement medium resources 103 that post the advertisement content or operate according to an advertisement post plan, and information resources 104 related to posting of the advertisement content. Generally, the advertisement medium resources 103 may include a device posting the advertisement content and a device providing an advertisement effect. For example, the advertisement medium resources 103 may include a screen device, an audio device, a lighting device, and the like. The information resources 104 may include network information of the advertisement medium resources 103, position information of the advertisement medium resources 103, and customer information of the advertisement medium resources 103.

The advertisement content posting system 101 may objectize the collected resources 102 and thereby generate the resource object information. Additionally, the advertisement content posting system 101 may generate resource relationship information according to relationships between pieces of the resource object information. The advertisement content posting system 101 may provide the resource object information and the resource relationship information to an advertiser medium 105 in the form of a web service. The advertiser medium 105, which is a medium connected with the advertisement content posting system 101, may receive the resource object information and the resource relationship information from the advertisement content posting system 101. Also, the advertiser medium 105 may receive an input of a post request for posting the advertisement content from the advertiser. For example, the advertiser medium 105 may include a computer, a notebook, a smart phone, a smart pad, and the like.

The advertisement content posting system 101 may post the advertisement content through the resources 102 selected by the advertiser according to the post request received from the advertiser medium 105. Here, the advertisement content posting system 101 may confirm the resource schedule information in response to the post request. In addition, the advertisement content posting system 101 may calculate a charge generated by posting of the advertisement content through the resources 102 according to a post schedule. The advertisement content posting system 101 may post the advertisement content through the resources 102 selected by the advertiser according to the post schedule based on payment processing and payment information corresponding to the charge.

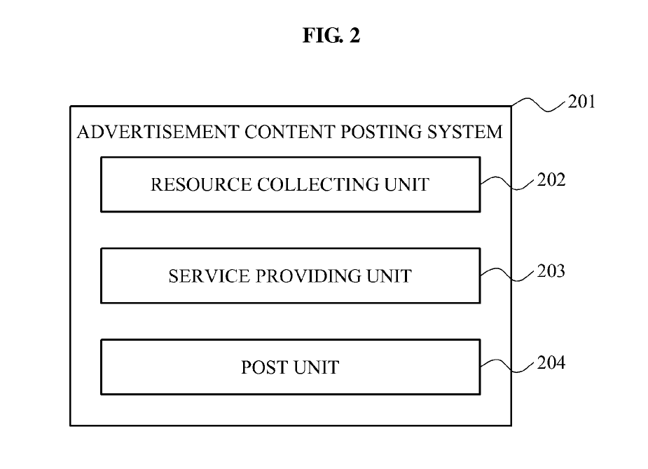

FIG. 2 is a diagram illustrating a detailed configuration of an advertisement content posting system 201 according to an embodiment of the present invention.

Referring to FIG. 2, the advertisement content posting system 201 may include a resource collecting unit 202, a service providing unit 203, and a post unit 204.

The resource collecting unit 202 may collect resources which are included in a particular domain and capable of posting an advertisement content. The resource collecting unit 202 may collect resources which are included in a particular domain and connected through a network. For example, the network may include all types of wired or wireless network utilized as a LAN or short range network, such as Ethernet, wireless LAN (WLAN), RS485, Zigbee, power line communication (PLC), and Bluetooth.

The resource collecting unit 202 may collect all resources that post the advertisement content or operate according to an advertisement post plan and are managed in the particular domain. The advertisement post plan may refer to a designated post time of the advertisement content to be posted through the resources according to demands of the advertiser. The resources refer to a device capable of posting the advertisement content. The resources may include advertisement medium resources and information resources. The resource collecting unit 202 may periodically collect the resources included in the particular domain.

The resource collecting unit 202 may include collecting modules corresponding to respective resources connected through the network. For example, the resource collecting unit 202 may collect the resources connected with the network through a plurality of collecting modules.

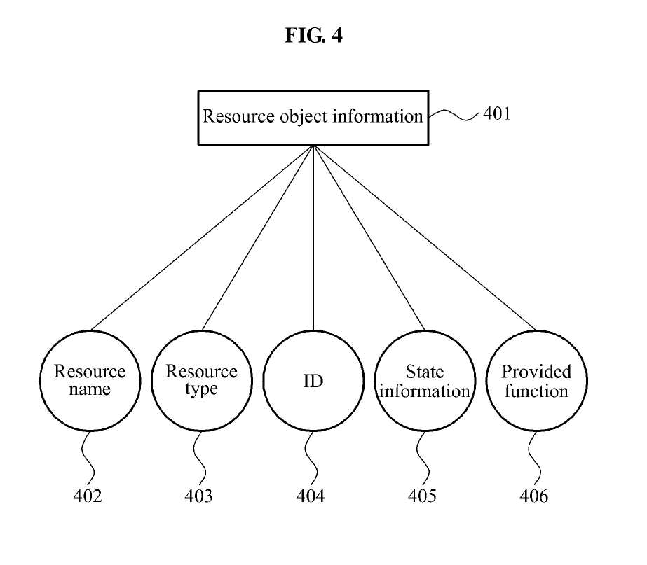

The service providing unit 203 may objectize the collected resources based on types of the resources, thereby generating the resource object information. That is, the service providing unit 203 may perform objectization according to the types of the resources, corresponding to a method of posting the advertisement content when the advertisement content is posted. For example, the service providing unit 203 may objectize the collected resources corresponding to screen resources posted in the form of a screen when the advertisement content is posted. Thus, the service providing unit 203 may generate the resource object information by objectizing the collected resources according to the type of the resources. The resource object information will be described with reference to FIG. 4.

The service providing unit 203 may generate the resource relationship information by analyzing relationships between the collected resources. Here, the service providing unit 203 may analyze relationships or attributes of the advertisement medium resources and the information resources in consideration of the particular domain the resources belong to. For example, the service providing unit 203 may analyze relationships among the screen resources, a position of the screen resources, the network, and a customer, in consideration of the screen resources belonging to a lobby of the particular domain. In addition, the service providing unit 203 may correct the resource relationship information according to a change, such as addition and deletion, in the information resource.

The service providing unit 203 may provide the advertiser with the resource object information and the resource relationship information in the form of a web service through an advertiser medium.

The advertiser may confirm available resources based on the resource object information and the resource relationship information provided in the form of the web service. In addition, the advertiser may determine the advertisement post plan according to the available resources. Here, the advertiser may confirm the available resources and determine the advertisement post plan through the advertiser medium connected with the advertisement content posting system. When the advertisement post plan is determined, the advertiser may transmit a post request related to the advertisement content to the advertisement content posting system through the advertiser medium.

The post unit 204 may post the advertisement content through resources selected by the advertiser based on the post request received from the advertiser medium. Here, before posting the advertisement content, the post unit 204 may calculate the charge generated by posting of the advertisement content through the resources according to the post request. The charge may be calculated in accordance with a charge calculation policy that includes an installation position of the resources in the particular domain, a size of the resources, a post schedule of the resources, floating population information at the installation position, the intensive post time, and the like.

The post unit 204 may transmit the calculated charge to the advertiser through the advertiser medium. The post unit 204 may post the advertisement content through the resources selected by the advertiser according to the post schedule based on payment processing and payment information of the charge. For example, the post unit 204 may post the advertisement content when payment of the charge is completed by the advertiser.

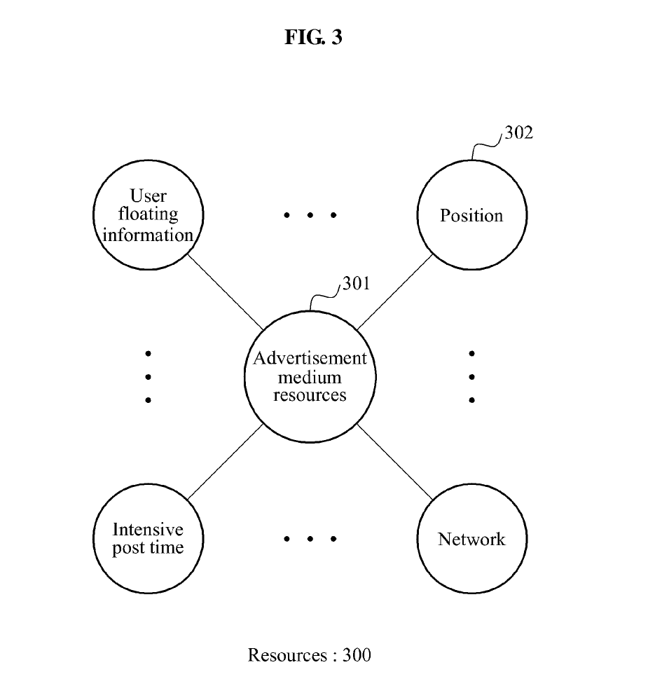

FIG. 3 is a diagram illustrating a detailed configuration of resources 300 capable of posting an advertisement content according to an embodiment of the present invention.

Referring to FIG. 3, the resources 300 may refer to a device or a network device included and installed in a particular domain.

The resources 300 may include advertisement medium resources 301 and information resources 302. The advertisement medium resources 301 may be a device that posts the advertisement content or operates according to an advertisement post plan when the advertisement content is posted. That is, the advertisement medium resources 301 may include a device displaying the advertisement content and an auxiliary device for more efficiently posting the advertisement content. For example, the advertisement medium resources 301 may include a notice board device for posting the advertisement content or a lighting device for spotlighting the advertisement content.

The information resources 302 may include information related to posting of the advertisement content. The information resources 302 may be information related to the advertisement medium resources 301 posting the advertisement content. The information resources 302 may include basic information related to the advertisement medium resources 301. That is, the information resources 302 may include network information, position information, customer information, intensive post time information, and the like of the advertisement medium resources 301.

FIG. 4 is a diagram illustrating resource object information 401 according to an embodiment of the present invention.

Referring to FIG. 4, the resource objet information 401 may include attribute information of resources included in a particular domain and managed. The attribute information may include a resource name 402, a resource type 403, an identifier (ID) 404, state information 405, and a provided function 406.

The resource name 402 may be a unique name of objectized resources. For example, the resource name 402 may be a name for indicating resources objectized as a screen 1, a screen 2, and the like.

The resource type 403 may refer to a method of posting an advertisement content through the objectized resources. The resource type 403 may be a type of sound resources posted in the form of a sound.

The ID 404 may be used to identify the objectized resources. The ID 404 may be S-01 corresponding to the screen resources.

The state information 405 may refer to a posting state of the advertisement content of the objectized resources. The state information 405 may be useful when the advertiser establishes an advertisement post plan with respect to the advertisement content. That is, the advertiser may determine availability of the resources based on the state information 405.

The provided function 406 may refer to a function of the objectized resources. That is, the provided function 406 may include a page up function, a page down function, a text disappearance function, and the like of a screen.

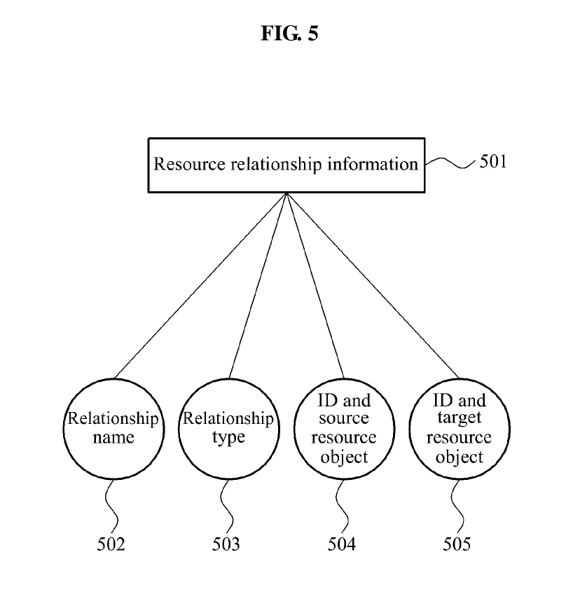

FIG. 5 is a diagram illustrating resource relationship information 501 according to an embodiment of the present invention.

Referring to FIG. 5, the resource relationship information 501 may define relationships between resources. The resource relationship information 501 may include a relationship name 502, a relationship type 502, and ID and source resource object 504 or ID and target resource object 505.

The relationship name 502 may be a name expressing relationships between resources. For example, the relationship name 502 may be connection according to screen resources and network resources.

The relationship type 503 may be a type by which the advertisement content is posted through the resources. For example, the relationship type 503 may be a speaker type that posts the advertisement content through a sound.

The ID and source resource object 504 may refer to resource object information corresponding to information resources such as a network and a service when the advertisement content is posted. For example, the ID and source resource object 504 may refer to the resource object information related to the information resources such as connection with the network or the service of the advertisement content for a device that posts the advertisement content or operates according to an advertisement post plan.

The ID and target resource object 505 may refer to resource object information related to advertisement medium resources that post the advertisement content or operate according to the advertisement post plan.

The resource relationship information may be configured in the form of a linked list of relationships between resources. Referring to FIGS. 4 to 5, the resource object information and the resource relationship information may be expressed by a graph model constituted by entities.

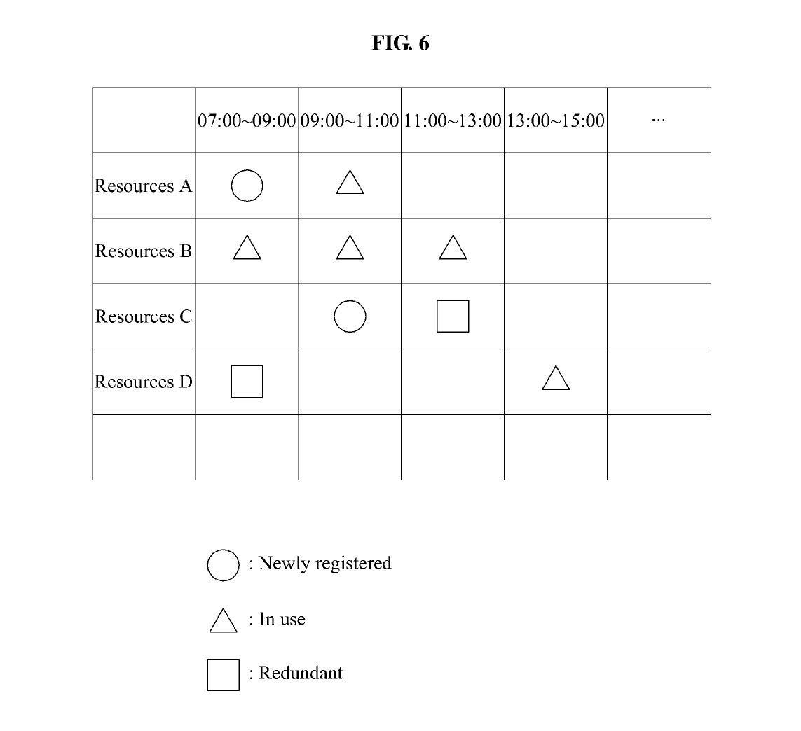

FIG. 6 is a diagram illustrating advertisement schedule information according to an embodiment of the present invention.

Referring to FIG. 6, the advertisement schedule information according to an advertisement post plan of an advertiser is shown.

The advertisement content posting system may compare the advertisement post plan received from the advertiser with the advertisement schedule information, thereby preventing redundancy with respect to the resources. The advertisement content posting system may check redundant schedule with respect to the resources through a post time selected in the advertisement post plan. In addition, by preventing the redundant schedule, the advertisement content posting system may efficiently post the advertisement content.

In addition, the advertisement content posting system may register a new schedule or cancel a schedule when the post time related to the resources selected by the advertiser is available.

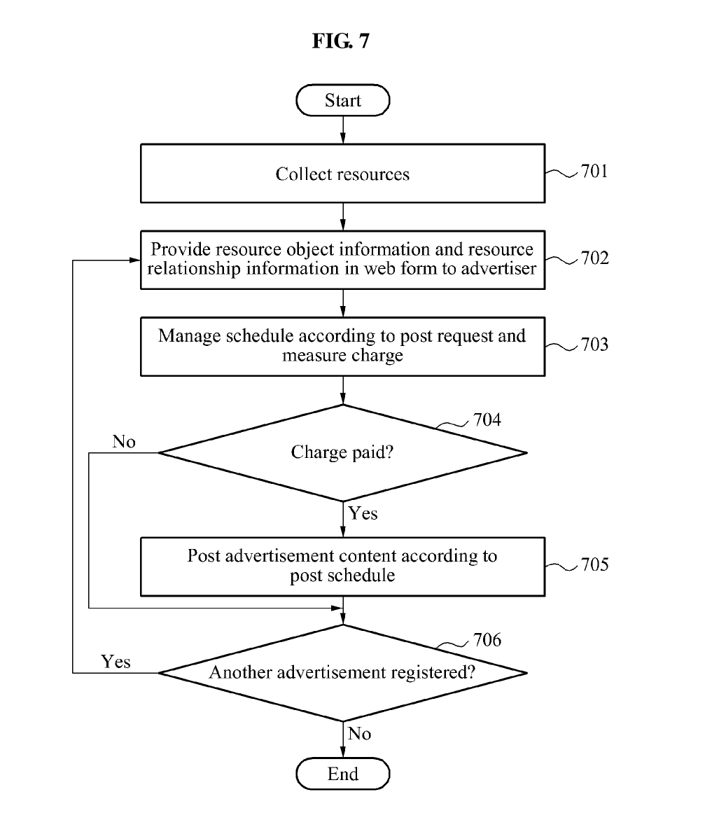

FIG. 7 is a diagram illustrating an advertisement content posting method according to an embodiment of the present invention.

In operation 701, an advertisement content posting system may collect resources which are included in a particular domain and capable of posting an advertisement content. The advertisement content posting system may collect all resources that post the advertisement content or operate according to an advertisement post plan and are managed in the particular domain. The resources refer to a device capable of posting the advertisement content, including advertisement medium resources and information resources. The advertisement posting system may periodically collect the resources included in the particular domain.

In operation 702, the advertisement content posting system may generate the resource object information by objectizing the collected resources according to the type of the resources. When posting the advertisement content, the advertisement content posting system may perform objectization according to the types of the resources, corresponding to a method of posting the advertisement content. By objectizing the resources according to the type of the resources, the advertisement posting system may generate the resource object information. The resource object information may include attribute information such as a resource name, a resource type, an ID, state information, and a provided function.

The advertisement content posting system may generate the resource relationship information by analyzing relationships between the collected resources. Here, the advertisement content posting system may analyze relationships or attributes of the advertisement medium resources and the information resources in consideration of the particular domain the resources belong to. The advertisement content posting system may correct the resource relationship information according to a change, such as addition and deletion, with respect to the information resource. In addition, the advertisement content posting system may update and manage the resource information and the object relationship information periodically. Here, the object relationship information may include a relationship name, a relationship type, and ID and source resource object or ID and target resource objet.

The advertisement content posting system may provide the generated resource object information and resource relationship information to the advertiser in the form of a web service.

In operation 703, the advertisement content posting system may receive a post request with respect to the advertisement content received from the advertiser. The advertisement content posting system may manage a post schedule according to the post request. The advertisement content posting system may calculate a charge generated by posting of the advertisement content through the resources according to the post schedule. The advertisement content posting system may post the advertisement content through the resources selected by the advertiser according to the post schedule based on payment processing and payment information corresponding to the charge. The advertisement content posting system may transmit the charge to the advertiser.

In operation 704, the advertisement content posting system may determine whether the charge calculated according to the post request of the advertiser is paid. The advertisement content posting system may determine a case in which the charge is paid and a case in which the charge is unpaid.

In operation 705, when the charge is paid, the advertisement content posting system may post the advertisement content based on the post schedule through the resources selected by the advertiser according to the post request of the advertiser.

In operation 706, the advertisement content posting system may check whether a post request related to another advertisement content is registered, the post request of the advertiser who transmits the post request of the foregoing advertisement content.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An advertisement content posting system comprising:
a resource collecting unit to collect resources included in a particular domain and configured to post an advertisement content;
a service providing unit to provide an advertiser with resource object information of the collected resources and resource relationship information between resources in a web service form; and
a post unit to post the advertisement content through resources selected by the advertiser when a post request with respect to the advertisement content is received from the advertiser.

2. The advertisement content posting system of claim 1, wherein the post unit comprises:
a schedule management unit to manage a post schedule related to the advertisement content corresponding to the post request; and
a charge unit to calculate a charge for use of the resources posting the advertisement content, in consideration of at least one of the resources, the post schedule, and a post time according to the post schedule.

3. The advertisement content posting system of claim 2, wherein the schedule management unit manages a redundant schedule by checking the post schedule of the resources corresponding to the post request, and manages a new schedule related to new registration of a post schedule of the resources or cancellation of the new registration

4. The advertisement content posting system of claim 2, wherein the charge unit calculates the charge corresponding to at least one of an installation position of the resources, a size of the resources, the post schedule of the resources, floating population information at the installation position, an intensive post time, and an advertisement post plan.

5. The advertisement content posting system of claim 1, wherein the resources comprises advertisement medium resources that post the advertisement content or operate according to the advertisement post plan, and advertisement medium information resources that include attribute information related to the advertisement medium resources.

6. The advertisement content posting system of claim 1, wherein the service providing unit objectizes the resources into the resource object information corresponding to a type of the resources posting the advertisement content.

7. The advertisement content posting system of claim 6, wherein the resource object information comprises at least one piece of attribute information among a resource name, a resource type, an identifier (ID), state information, and a provided function related to the objectized resources.

8. The advertisement content posting system of claim 1, wherein the service providing unit generates resource relationship information according to relationship with the resource object information, in consideration of the particular domain including the resources.

9. The advertisement content posting system of claim 8, wherein the resource relationship information comprises at least one of a relationship name, a relationship type, and ID and source resource object or ID and target resource objet, according to relationship with the resource object information.

10. The advertisement content posting system of claim 1, wherein the post unit posts the advertisement content through the resources selected by the advertiser according to the post request when the charge according to the post schedule of the advertiser is paid.

11. An advertisement content posting method comprising:
collecting resources included in a particular domain and configured to post an advertisement content;
providing an advertiser with resource object information of the collected resources and resource relationship information between resources in a web service form; and
posting the advertisement content through resources selected by the advertiser when a post request with respect to the advertisement content is received from the advertiser.

12. The advertisement content posting method of claim 11, wherein the posting of the advertisement content comprises:
managing a post schedule related to the advertisement content corresponding to the post request; and
calculating a charge for use of the resources posting the advertisement content, in consideration of at least one of the resources, the post schedule, and a post time according to the post schedule.

13. The advertisement content posting method of claim 12, wherein the managing comprises:
managing a redundant schedule by checking the post schedule of the resources corresponding to the post request; and
managing a new schedule related to new registration of a post schedule of the resources or cancellation of the new registration

14. The advertisement content posting method of claim 12, wherein the calculating comprises calculating the charge corresponding to at least one of an installation position of the resources, a size of the resources, the post schedule of the resources, floating population information at the installation position, an intensive post time, and an advertisement post plan.

15. The advertisement content posting method of claim 11, wherein the resources comprises
advertisement medium resources that post the advertisement content or operate according to the advertisement post plan, and advertisement medium information resources that include attribute information related to the advertisement medium resources.

16. The advertisement content posting method of claim 11, wherein the providing comprises objectizing the resources into the resource object information corresponding to a type of the resources posting the advertisement content.

17. The advertisement content posting method of claim 16, wherein the resource object information comprises at least one piece of attribute information among a resource name, a resource type, an identifier (ID), state information, and a provided function related to the objectized resources.

18. The advertisement content posting method of claim 11, wherein the providing comprises generating resource relationship information according to relationship with the resource object information, in consideration of the particular domain including the resources.

19. The advertisement content posting method of claim 18, wherein the resource relationship information comprises at least one of a relationship name, a relationship type, and ID and source resource object or ID and target resource objet, according to relationship with the resource object information.

20. The advertisement content posting method of claim 11, wherein the posting of the advertisement content comprises posting the advertisement content through the resources selected by the advertiser according to the post request when the charge according to the post schedule of the advertiser is paid.
